(19) United States
(12) Patent Application Publication
(10) Pub. No.: US 2018/0222676 A1
(43) Pub. Date: Aug. 9, 2018

(54) A MULTI-STOREY GOODS STORAGE ARRANGEMENT

(71) Applicant: LOGEVO AB, Almhult (SE)

(72) Inventor: Bo LINDBLOM, OSBY (SE)

(21) Appl. No.: 15/565,314

(22) PCT Filed: Apr. 13, 2016
(86) PCT No.: PCT/SE2016/050323

§ 371 Date: Oct. 9, 2017

(30) Foreign Application Priority Data
Apr. 14, 2015 (SE) 1550447-5

(51) Int. Cl. B65G 1/04; B65G 1/137

(52) U.S. Cl. CPC B65G 1/0414; B65G 1/137; B65G 1/0464

(57) ABSTRACT

A multi-storey goods storage arrangement and a method of operating it, said multi-storey goods storage arrangement comprising a plurality of levels of storage lines arranged in parallel, each storage line supporting a plurality of baseboards with packages, and transport aisles extending in parallel between opposing ends of sets of said storage lines, wherein at least one baseboard transfer cart is operable along each transport aisle. Picking aisles extending in parallel between opposing ends of sets of said storage lines and at least one picker transfer cart operates along each picking aisle, each picker transfer cart supporting at least one picker cart. Said picker cart comprises lifting means to lift goods stored in said storage lines and to transport lifted goods to a picking aisle. At least one first conveyor is extending horizontally and is receiving goods from said at least one picking cart by lowering the goods.

### TECHNICAL FIELD

A multi-storey goods storage arrangement comprising a plurality of levels of storage lines arranged in parallel, each storage line supporting a plurality of baseboards with package), and transport aisles extending in parallel between opposing ends of sets of said storage lines, wherein at least one baseboard transfer cart is operable along each transport aisle.

### PRIOR ART

Multi-storey goods storage arrangements or pallet racks are used in a wide area of applications, such as conventional warehouses, storages and stores. Goods, such as packages or cases, are normally arranged on pallets that are transported in the multi-storey goods storage arrangement by different kinds of carts, carriages, shuttles and conveyors. In automated multi-storey goods storage arrangements the carriages, shuttles and conveyors are controlled by computer systems and pick up, transport, store and deliver goods without human influence.

In some multi-storey goods storage arrangements manual picking from pallets on a picking line is used to combine different objects from different pallets into mixed pallets for delivery or packaging. Pallets with selected goods may be collected automatically from the multi-storey goods storage arrangement to a picking line. A mixed pallet is then manually put together and the collected pallets with remaining goods are again dispatched automatically in the multi-storey goods storage arrangement.

### SUMMARY OF THE INVENTION

It would be desirable to improve the process in prior art multi-storey goods storage arrangements of putting together a mixed pallet of different items or goods. The multi-storey goods storage arrangement comprises a plurality of levels of storage lines arranged in parallel and transport aisles or lines extending between opposing ends of said storage lines. At least one picking aisle extends in parallel between opposing ends of sets of said storage lines and in parallel with said transport aisles. At least one pallet or baseboard transfer cart is operable along each transport aisle to move pallets or baseboards supporting goods to selected positions in said storage lines.

In various embodiments said pallet or baseboard transfer cart comprises an elevating means. The elevating means moves a pallet or baseboard horizontally between at least two levels in the multi-storey goods storage arrangements.

At least one picker transfer cart is operating along each picking aisle at each level and each picker transfer cart supports a picker cart. The picker carts are suspended from the picker transfer carts and are operable from the picker transfer carts into the storage lines. The picker carts are provided with means for picking up goods stored on pallets or baseboards. After returning to the picker transfer cart and positioning the picker transfer cart above a conveyor at a lower level the goods is lowered and placed on a pallet or a baseboard placed on the conveyor. A mixed pallet is formed by adding further items on the pallet or baseboard. In various embodiments a completed mixed pallet is moved on the conveyor to a track extending perpendicular to the conveyor and further out of the goods storage arrangement.

The means for picking up goods comprises lifting means and a hoist having an operational range of at least two levels in the goods storage arrangement. In various embodiments the means for picking up goods comprises a lifting yoke with a suction device. It also comprises a locking device. The locking device will ensure that goods will remain in position on the lifting means, should the suction device be faulty.

In various embodiments the picker carts suspend from a top rail arrangement on said picker transfer cart and are moveable out from said picker transfer cart into a suspension rail arrangement in said storage lines.

In various embodiments said at least one pallet or baseboard transfer cart is arranged to transport goods on a pallet or baseboard in a vertical direction between different levels of storage lines. Each pallet or baseboard transfer cart supports at least one shuttle and is operable along each transport line. Each shuttle is self-operated and arranged to run along rails in the storage lines to move goods on a pallet or baseboard between the transfer cart and different positions in the storage lines.

In various embodiments said picker carts are provided with a cable winder. The cable of the cable winder is electrically connected to a power outlet on said for providing electric power to the lifting yoke and to said locking device. The length of the cable extends the length of a storage line and also the distance from a top level of the multi-storey goods storage arrangement the level where the conveyor is arranged. As a result the lifting yoke is provided with electric power during operation.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 is a schematic partial top view of one level of a first embodiment of a multi-storey goods storage arrangement in accordance with the invention,

FIG. 2 is a schematic side view of an embodiment of a picking aisle in a four level multi-storey goods storage arrangement in accordance with the invention,

FIG. 3 is a schematic partial top view of a conveyor level of the multi-storey goods arrangement shown in FIG. 1,

FIG. 4 is a schematic top view of a picker cart in a position in a storage line and a picker transfer cart in a position in a picking aisle,

FIG. 5 is a schematic top view of a picker cart suspended from a picker transfer cart in a position in a picking aisle,

FIG. 6 is a schematic side view of the picker cart and the transfer cart in the position shown in FIG. 5,

FIG. 7 is a schematic top view of a picker cart with a locking device in a locked position,

FIG. 8 is a schematic top view of a picker cart with a locking device in an unlocked position,

FIG. 9 is a schematic side view of the picker cart supporting goods in a lower position,

FIG. 10 is a schematic side view of the picker cart in FIG. 9 after placing goods on a baseboard,

FIG. 11 is a schematic top view of elements of a picker cart in a position where the cable winder is in a fully withdrawn position,

FIG. 12 is a schematic side view showing the elements of a picker cart in the same position as shown in FIG. 11,

FIG. 13a is a schematic side view showing the elements of a picker cart in an end position in a storage line with a fully extended electric wire,

FIG. 13b is a schematic side view showing the elements of a picker cart in lowered position with a fully extended electric wire,

FIG. 14 is a schematic top view showing elements of a picker cart in position in a storage line,

FIG. 15 is a schematic top view showing elements of an alternative embodiment of picker cart in position in a storage line,

FIG. 16 is a schematic side view of an embodiment of a transport aisle in a four level multi-storey goods storage arrangement showing a baseboard transfer cart in accordance with one embodiment of the invention,

FIG. 17 is a schematic side view showing a shuttle in a storage line,

FIG. 18 is a schematic side view showing elements of an alternative embodiment of a locking device in a picker cart and

FIG. 19 is a schematic partial top view of a conveyor level of the multi-storey goods arrangement shown in FIG. 1.

### DETAILED DESCRIPTION

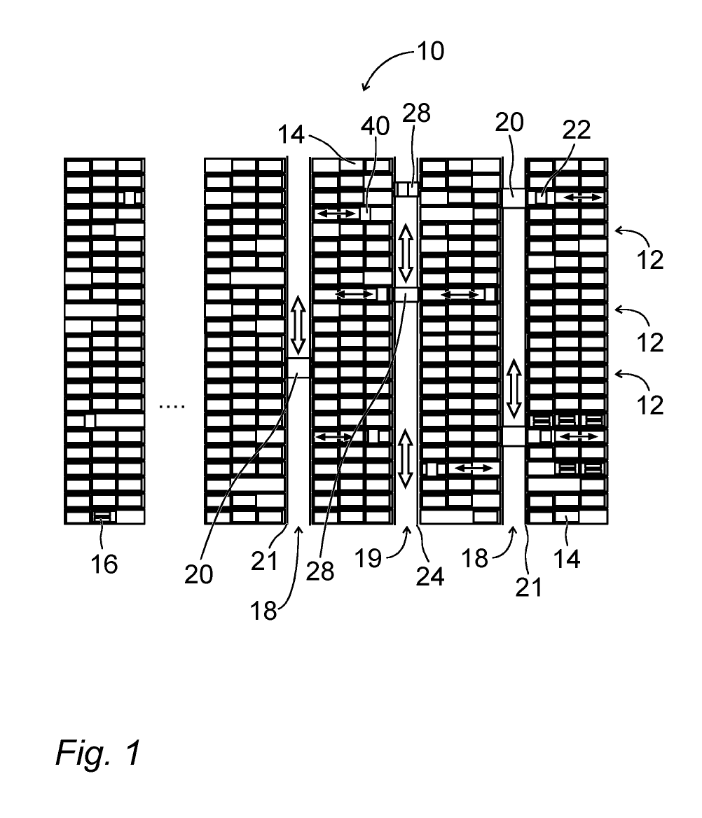

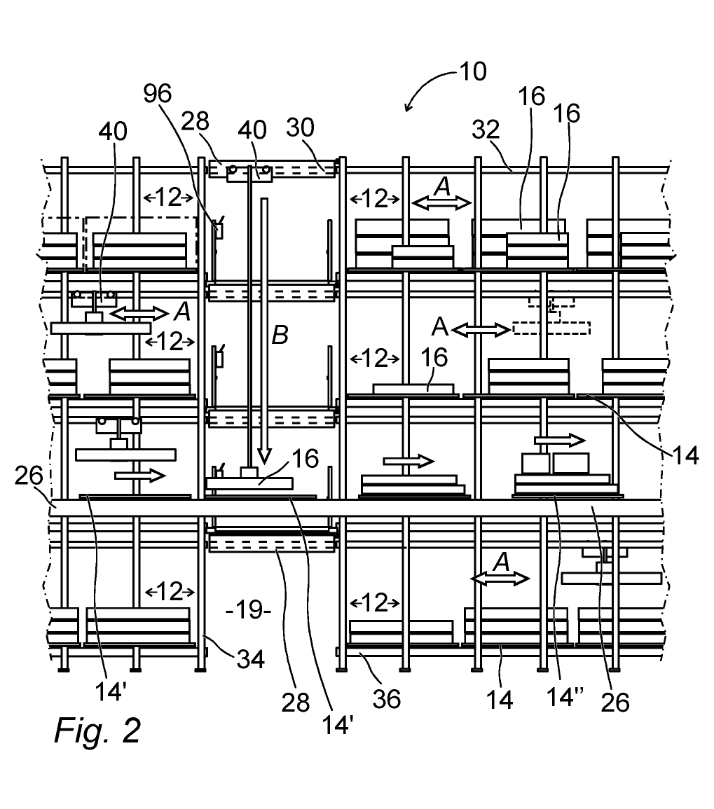

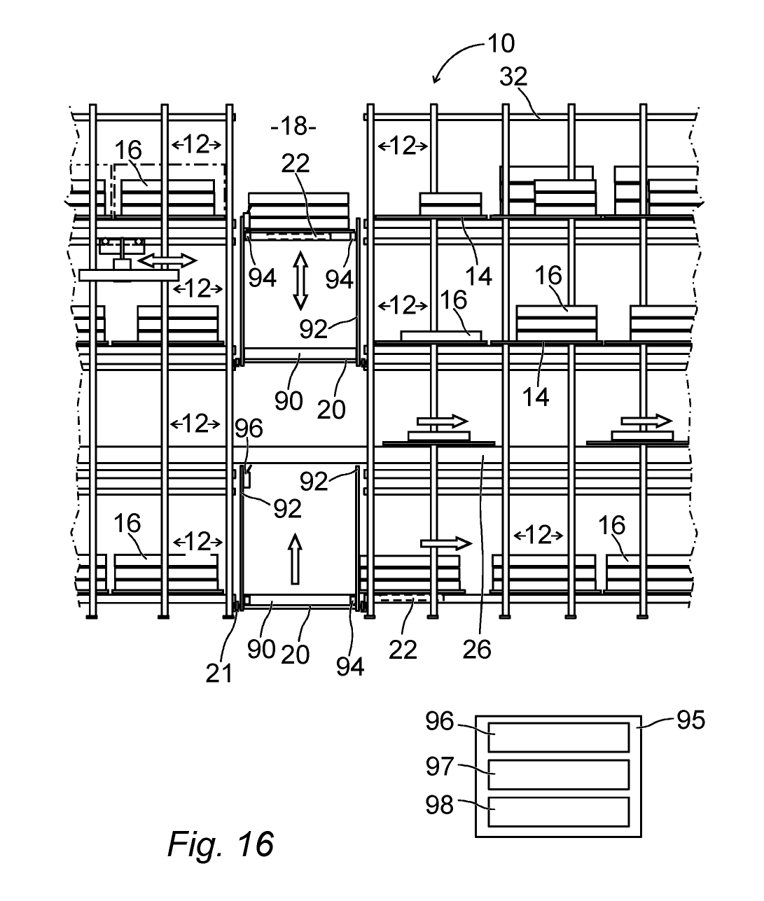

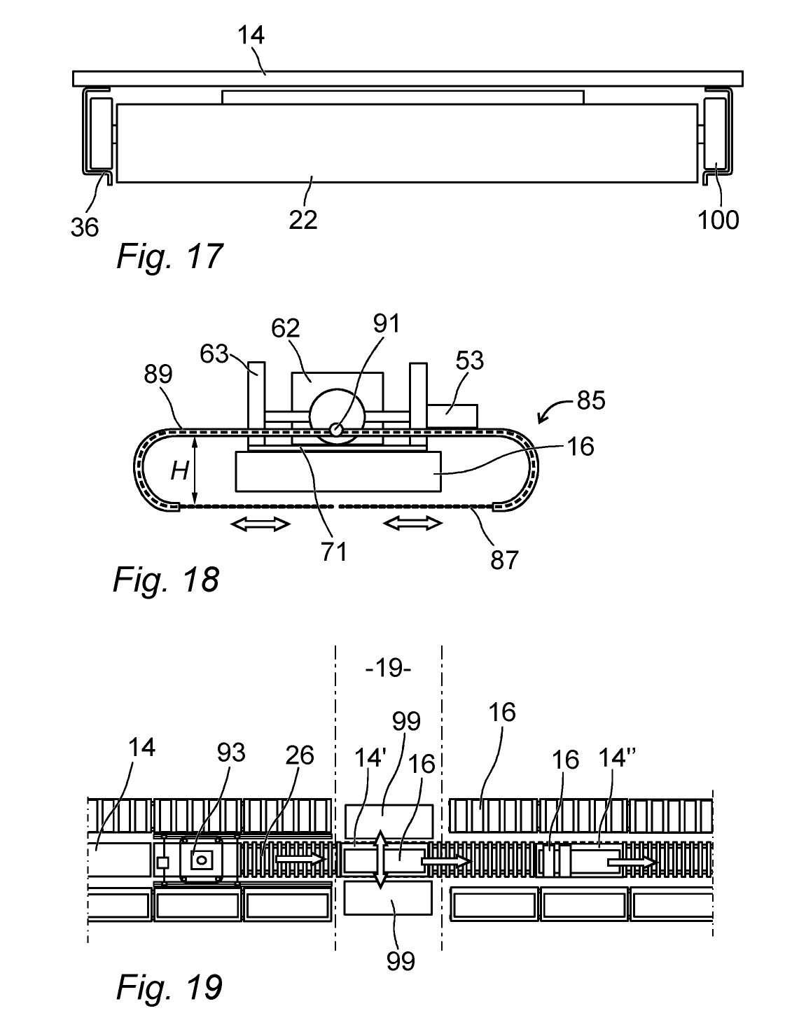

In the embodiment shown in FIG. 1 and FIG. 2 a multi-storey goods storage arrangement or pallet racking 10 comprises a plurality of levels of storage lines 12 in which pallets 14 with goods 16 are stored. The storage lines 12 extend in two opposite directions from transport lines 18 extending between opposite ends of said storage lines 12, said transport lines 18 also having a plurality of levels. Baseboard transfer carts 20 supporting a shuttle 22 operate in said transport lines 18 in a direction perpendicular to the storage lines 12. The baseboard transfer carts 20 run on transport rails 21, c.f. FIG. 16. The shuttle 22 is supported in a conventional way on a rail system in a lower section of the baseboard transfer cart 20. A corresponding rail system extends along said storage lines 12 to allow said shuttle 22 to transport pallets 14 to and from selected positions along said storage lines 12.

The rail system in said storage lines also supports baseboards or pallets 14 on which goods 16 is stored. Normally each baseboard 14 in one storage line 12 supports one type of articles or goods. Goods are received to and delivered from the multi-storey goods storage arrangement through different means.

Each shuttle 22 is arranged to move away from the transfer cart 20 into said storage lines 12 carrying goods 16. The baseboards 14 can be transported along a storage line 12 to be placed at a selected position in the storage line 12. The baseboards 14 also can be picked up at a selected position by the shuttle 22 and transported to the transfer cart 20 which then will transport the picked up pallet along the transport line to a selected new storage line.

The multi-storey goods storage arrangement basically is a pallet racking with a plurality of uprights 34 and horizontal load beams 36. The load beams 36 can be designed as or include said rail system for supporting the shuttle 22. Conventional diagonal braces and horizontal braces can also be used.

The shuttle 22 moves from the transfer cart 20 into the storage lines 12 and back carrying pallets 14 with or without goods 16. The shuttle 22 is provided with support means that can be raised in position under a pallet 14 and kept in a raised position during transport in the storage line 12. When goods have reached an intended position in the storage line or elsewhere the support means is lowered and the goods will rest on rails or load beams 36 or on the baseboard transfer cart 20.

The multi-storey goods storage arrangement shown in FIG. 1 and FIG. 2 comprises also picking aisles 19 in which picker transfer carts 28 operate. The picking aisles 19 extend parallel to the transport aisles 18 and are normally arranged between transport aisles 18 forming an arrangement with alternating transport aisles 18 and picking aisles 19. Picker transfer carts 28 operate back and forth in each picking aisle 19 running on rails 24. Each picker transfer cart 28 supports a picker cart 40 suspended from a top rail arrangement 30 and movable into and out of a suspension rail arrangement 32 in the storage lines 12 as indicated by arrow A.

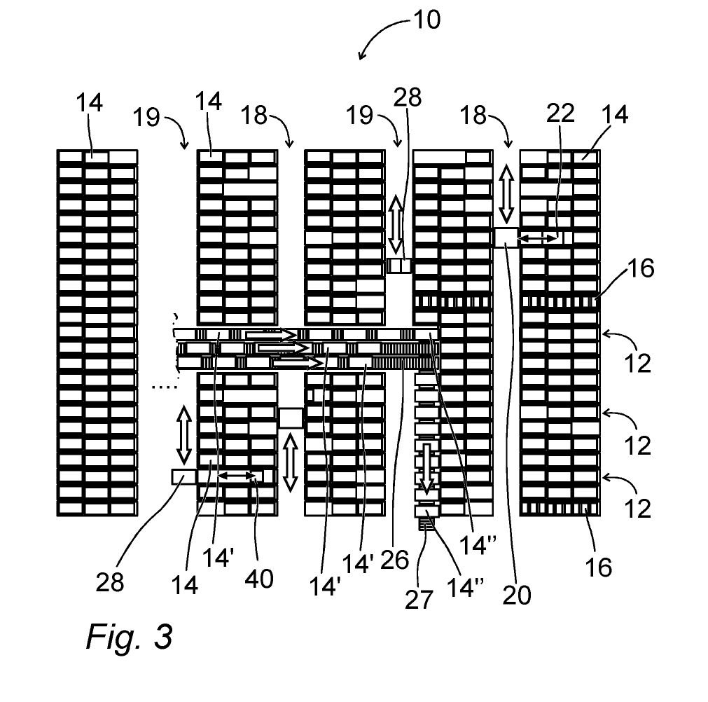

At one level of the multi-storey goods storage arrangement in accordance with the invention there is arranged first conveyors 26, c.f. FIG. 3. In the embodiment shown in FIG. 2 said first conveyors 26 are arranged on the second level. Empty baseboards 14 are placed on said first conveyors 26 running in parallel with storage lines and then positioned in a picking aisle 19. In various embodiments said first conveyors 26 are roller conveyers. When positioned in a picking aisle 19 goods picked up by a picker cart 40 in a storage line 12 and moved to a picker transfer cart 28 in a picking aisle 19 is lowered as depicted by arrow B and placed on an empty baseboard forming a picking baseboard 14′. Further packages or goods 16 then can be picked up by picker carts (the same or other ones) and placed on the picking baseboard 14′.

A picking baseboard that is completed with all goods for delivery from the multi-storey goods storage arrangement 10 is referred to as a ready baseboard 14″ as shown to the right in FIG. 2. The ready baseboard 14″ normally carries different goods or articles combined for delivery to a customer and is transported on the first conveyors 26 to a delivery position at a second conveyor 27, c.f. FIG. 3. In various embodiments said second conveyor 27 is a chain conveyor. Goods stored on the first level of the multi-storey goods storage arrangement as shown in FIG. 2 is picked up a picker cart 40 operating in that level and disposed on a baseboard at a position where a picker cart 40 of the second level picks it up, lifts it up and places it on the first conveyor as 26 disclosed above.

FIG. 3 illustrates an embodiment of a multi-storey goods storage arrangement in accordance with the invention in which three first conveyors 26 are arranged in parallel in a central position. On each of said first conveyors a plurality of picking baseboards 14′ are transported towards a second conveyor 27 extending perpendicular to said first conveyors 26. A ready baseboard 14″ carrying all items and goods for a delivery has reached the second conveyor 27 and will be further transported along said second conveyor 27. During normal operation a plurality of ready baseboards 14″ will be transported on said second conveyor 27 out of the multi-storey goods storage arrangement.

In each transport aisle 18 at least one baseboard transfer cart 20 operates to transport baseboards 14 with goods using shuttles 22 to selected positions in the storage lines 12. In each picking aisle 19 at least one picker transfer cart 28 is arranged to pick up goods 16 in the storage lines 12 using a picker cart 40 and to place it one of said first conveyors 26. The shuttles 22 and the picker carts 40 have an operation distance corresponding the length of a storage line 12 between a transport aisle 18 and a picking aisle 19. All baseboards 14 and goods 16, respectively, in each storage line thus can be reached and positioned correctly.

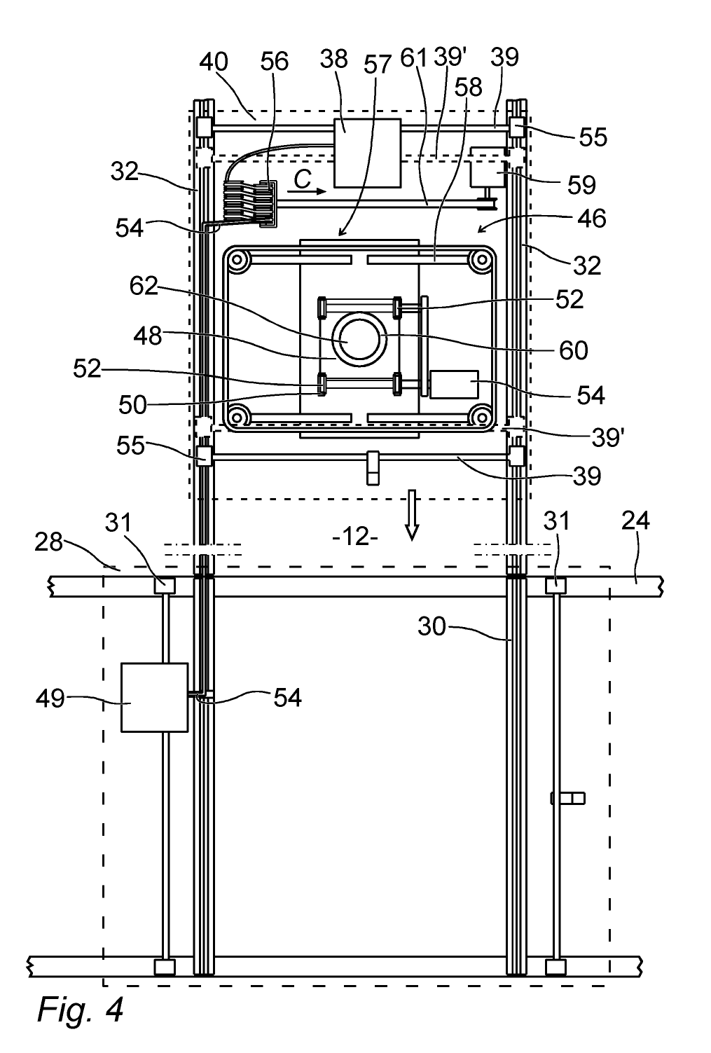

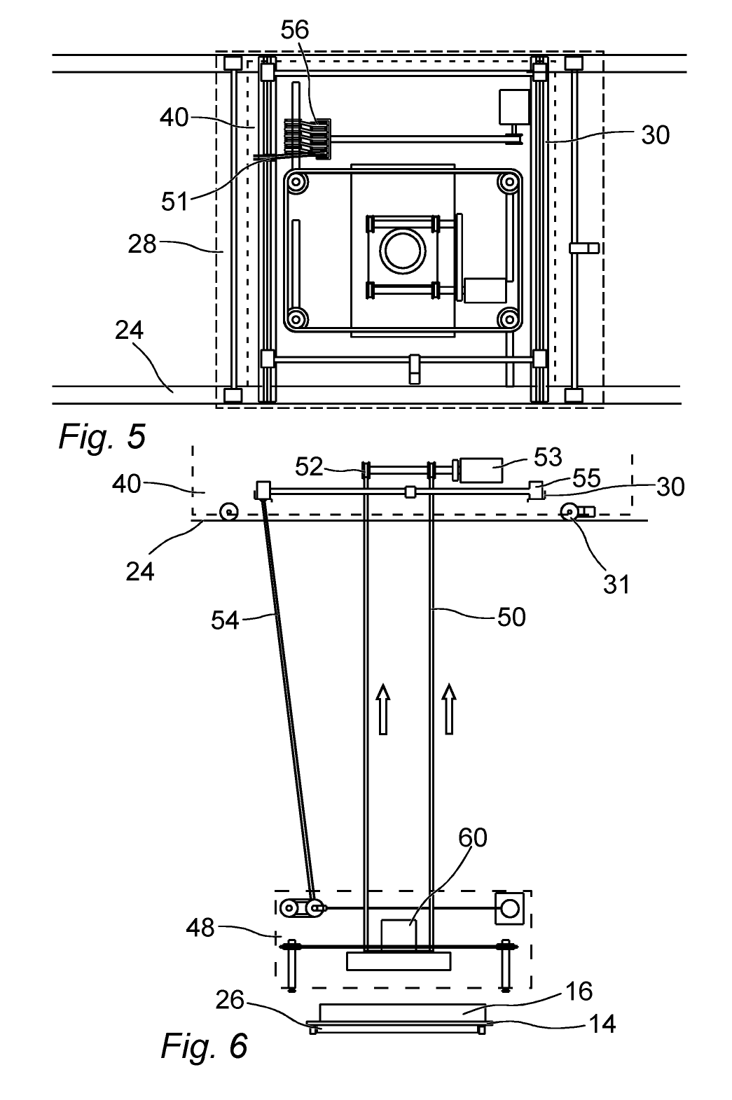

In various embodiments the picker cart 40 comprises lifting means 46 for lifting goods disposed on pallets in the storage lines 12. The lifting means 46 is designed in dependence on the type of goods, packages or boxes that are stored in the storage lines 12. In the embodiment shown in FIG. 4 the lifting means 46 comprises a lifting yoke 48 suspended in hoisting belts 50, c.f. FIG. 5 and FIG. 6.

The picker cart 40 shown in FIG. 4 has moved into an end position in a storage line 12 suspended from said top rail arrangement 30 in picker transfer cart 28 and from said suspension rail arrangement 32 in said storage line 12. The picker cart 40 runs on support wheels 55. The picker transfer cart 28 runs in a similar way on cart wheels 31 supported on said rails 24. An electric motor 38 drives the wheels 55 through drive shafts 39. A chain (not shown) or similar drive means can be arranged between shafts 39. Normally, there are provided double shafts each supporting two wheels 55 at each end of the picker cart 40 to facilitate movement from said top rail arrangement 30 in a storage line to said suspension rail arrangement 32 in said picker transfer cart 28. A second set of shafts 39′ is indicated in FIG. 4.

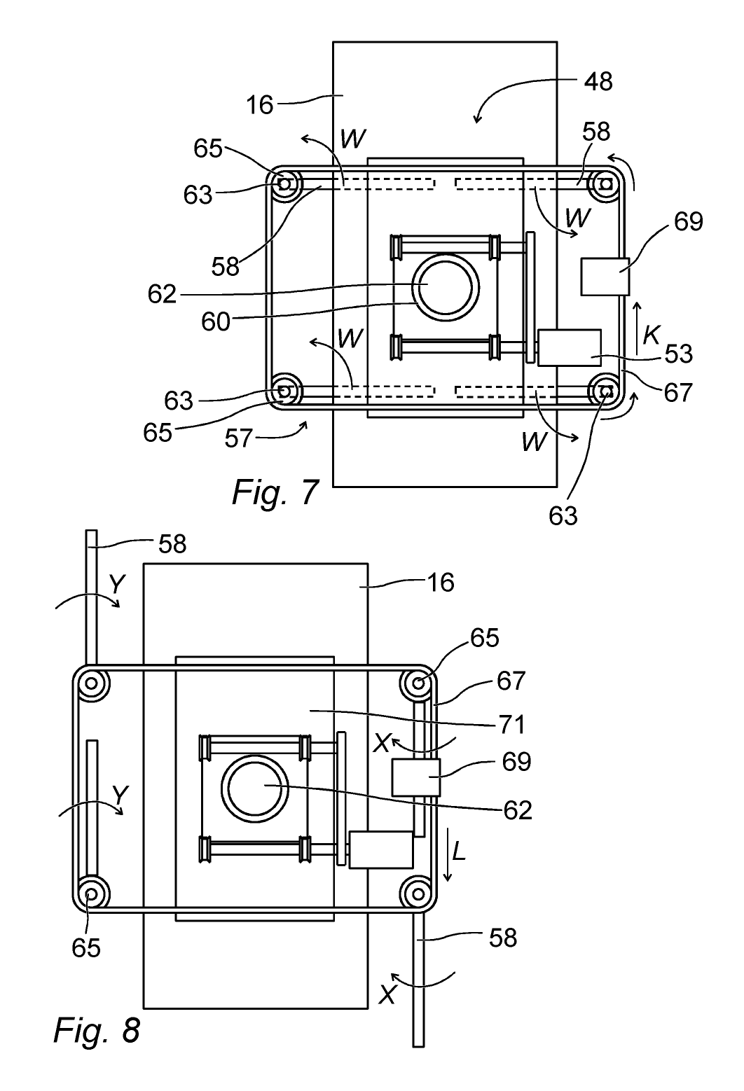

The picker cart 40 supports lifting means 46 comprising a lifting yoke 48 suspended in hoisting belts 50, c.f. FIG. 6. The hoisting belts 50 are suspended from hoisting wheels 52 driven by a motor and gearbox 53. The electric motor 38 includes a gearbox. The lifting yoke 48 comprises a fan such as a suction device 60 driven by a suction motor 62. The electric motor 38 and other electric equipment of the picker cart 40 can be provided with electric power from a power outlet 49 on the picker transfer cart 28 through an electric wire 54. The lifting yoke 48 further comprises a locking device 57 for supporting and locking goods to the lifting yoke during hoisting. In the embodiment shown in FIG. 4 the locking device 57 comprises four rotatable locking arms 58. The function of the locking device 57 is further explained below with reference to FIG. 7 and FIG. 8. The picker transfer cart 28 is powered through a conductor rail (not shown) in the rails 24.

In various embodiments the power used by the electric motor 38 and other electric equipment of the picker cart 40 is reduced and a mobile power supply comprising super capacitors or similar charge storing devices replaces the power outlet and electric wire 54. In such embodiments the charge storing devices are charged when the picker cart 40 has returned to the picker transfer cart 28.

The suction device 60 and particularly the suction plate 71 are designed and arranged in dependency of the shape and weight of packages 16. Normally, one type of packages is arranged together in one or a plurality of storage lines 12. As a result a picker cart 40 supporting a suitable suction device 60 and suction plate 71 is associated to and operates in these storage lines 12.

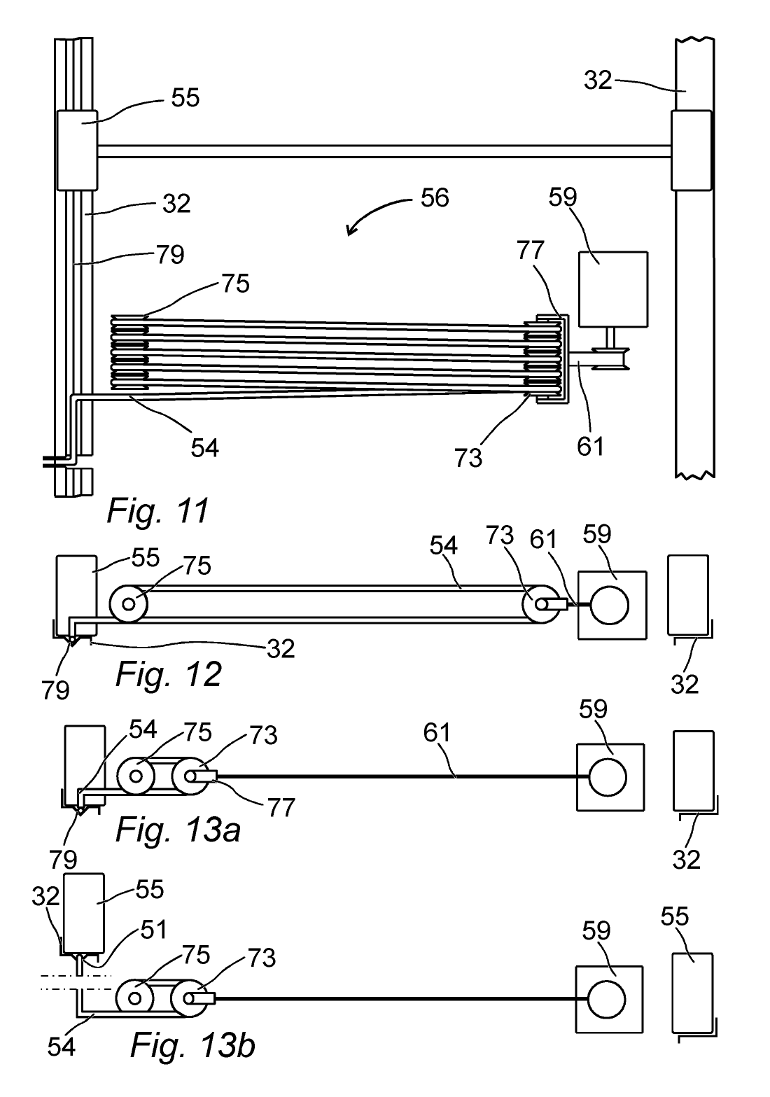

The electric wire 54 has a length at least corresponding to the length of a storage line 12 from a picking aisle to an end of the storage line and is winded on a cable winder 56, c.f. FIG. 11-FIG. 13. In the embodiment shown in FIG. 4 the cable winder 56 is arranged as a block and tackle unit. A tension motor 59 operates on a belt 61 to pull the cable winder back as depicted by arrow C when the picker cart 40 returns to a position on the picker transfer cart 28.

In the position shown in FIG. 5 and FIG. 6 the picker cart 40 has returned to the picker transfer cart 28, lowered the lifting yoke 48 and released goods 16 by opening the locking device. The picker cart 40 is supported on the top rail arrangement 30 while situated on the picker transfer cart 28. The picker transfer cart 28 rests on the rail 24. It should be noted that the cable winder 56 has been substantially extended, so as to allow the lifting yoke 48 with suction device 60 to be electrically powered during movement. The electric wire 54 extends through an opening 51 in the top rail arrangement 30. The goods 16 have been placed on a baseboard 14 on said first conveyor 26 for further handling. The hoisting belts 50 are almost fully unwound from the hoisting wheels 52.

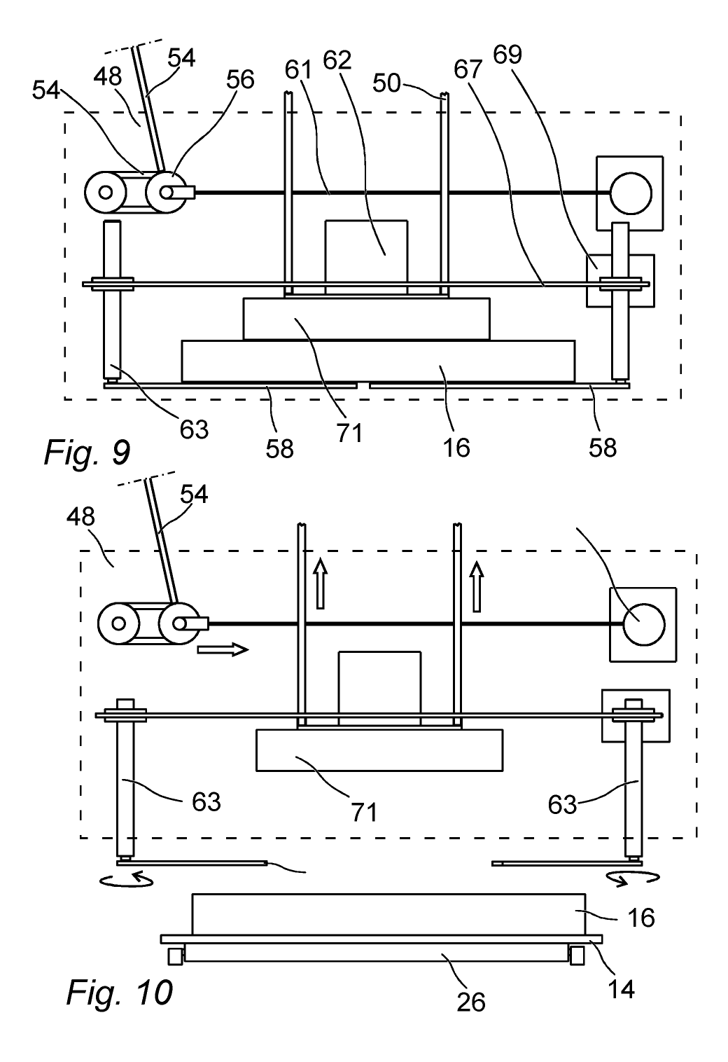

FIG. 7 and FIG. 8 illustrate the function of one embodiment of the locking device 57. Four locking arms 58 are rotatable about 90 degrees on threaded rods 63 as depicted by arrow W. In the position shown in FIG. 7 the locking arms 58 are in a locked position below goods such as a package 16. The suction motor 62 can also activated in this position to maintain the package in the desired position but normally the locking arms 58 will suffice. A nut 65 with sprockets is arranged on each threaded rod 63, c.f. FIG. 9, and a chain 67 connects all nuts 65 with sprockets. A chain motor 69 is provided for driving the chain 67. By driving the chain 67 in the direction of arrow K the locking arms 58 and the threaded rods 63 will be rotated as indicated by arrow W and the goods 16 will be released.

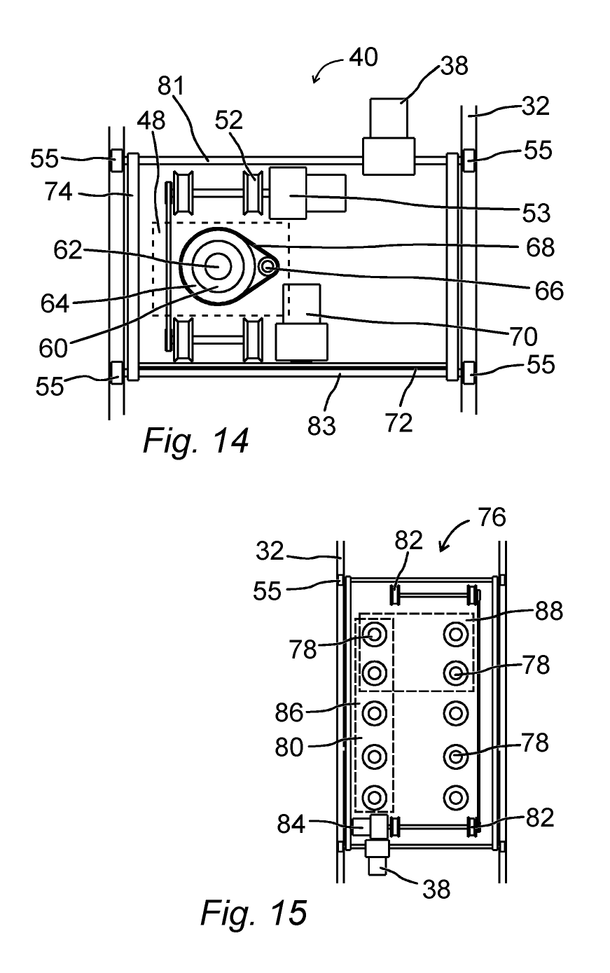

The position of the locking arms 58 shown in FIG. 8 will allow the picker cart 40 to move along the suspension rail arrangement to a position above a package 16. The lifting yoke 48 is adjustable in a horizontal plane, so as to be centred above the package and can also be rotated. When correctly positioned above the package 16 the lifting yoke 48 is lowered until a suction plate 71 engages a top surface of the package 16. In this position the suction motor 62 is switched on and the package can be lifted by activating the motor and gearbox 53, c.f. FIG. 6 and FIG. 14.

When the package 16 has been lifted the chain motor 69 is activated and the chain 67 is driven in the direction of arrow L. As a result the nuts 65 with sprockets will rotate. An interlock in the nuts 65 with sprockets will force the threaded rods 63 and the locking arms 58 to rotate as depicted by arrows X and Y during an initial step. When the locking arms 58 have rotated about 90 degrees the interlock will be released. A continued movement of chain 67 by the chain motor 69 will continue the rotation of the nuts 65 with sprockets in a second step and the threaded rods 63 will be raised without rotation, c.f. FIG. 9 and FIG. 10. A sensor (not shown) will provide a signal when the locking arms 58 engage a bottom side of the package 16 and the driving of the chain 67 will cease. In this position the package is fixed by the locking arms 58 and the suction motor 62 can be turned off to save energy. The picker cart 40 carrying the package 16 then can be moved along the storage line 12 back to the picker transfer cart 28 and further on to an appropriate position above the first conveyors 26 as described above with reference to FIG. 2.

In various embodiments the locking device 57 comprises bows or gripping arms (not shown) that can be rotated in a vertical plane to engage a package 16 from below and to ensure that the packages is maintained in position during transporting. In still other embodiments the locking device 57 comprises guides that are guided in hollow arms to be pushed into a position below the package 16, c.f FIG. 18.

The lifting yoke 48 as shown in FIG. 9 has been lowered with a package 16 in a fixed position secured by locking arms 58. During this step the suction motor 62 can be switched off. The cable winder 56 with the electric wire 54 is close to be fully extended because the lifting yoke 48 is close to a lowermost position. Also the hoisting belts 50 are almost fully extended. The chain motor 69 is not activated and the chain 67 as well as the threaded rods 63 are stationary to maintain the locking arms 58 in the position shown in FIG. 9.

From the position of the lifting yoke 48 shown in FIG. 9 the lifting yoke 48 is further lowered until the package 16 is close to engage or engages a baseboard 14, c.f. FIG. 10. In this position (not shown) the suction motor 62 is activated so as to safely engage the suction plate 71 to the package 16. Then the chain motor 69 is activated and the chain 67 starts to rotate the nuts 65 with sprockets. As a result the threaded rods 63 are lowered and the locking arms 58 are released from the package 16.

When the threaded rods 63 have reached a lower position as shown in FIG. 10 the interlock of the nuts 65 with sprockets will force the locking arms 58 to rotate back towards the position shown in FIG. 8. When that position has been reached the lifting yoke 48 again is hoisted to a starting position on the picker cart. During hoisting of the lifting yoke 48 the tension motor 59 is operated to pull back the cable winder 56 and wind up the electric wire 54. The package 16 placed on a baseboard 14 and the baseboard 14 bear on the first conveyor 26. Further packages then optionally can be placed on top of the package already placed.

FIG. 11 and FIG. 12 show in more detail the cable winder 56 in a fully withdrawn position. The cable winder 56 is supported on the picker cart 40 that is positioned with support wheels 55 on the suspension rail arrangement 32. Substantially the full length of the electric wire 54 is winded on a first set 73 and a second set 75 of grooved pulleys. The first set 73 of grooved pulleys is arranged on a support 77 that is connected to said belt 61. The tension motor 59 is operated to maintain an appropriate tension in the electric wire 54 to avoid sagging. When the picker cart 40 moves along the suspension rail arrangement 32 the electric wire 54 is received in a recess 79 that extends along said suspension rail arrangement 32. In the embodiment shown in FIG. 10-FIG. 13 the rail on one side only of the suspension rail arrangement 32 is formed with the recess 79. In various other embodiments rails on both sides are formed with the recess 79.

In the position shown in FIG. 13a the belt 61 is substantially fully extended and a major part of the electric wire 54 has been withdrawn from the cable winder 56 and extends in the recess 79. As shown in FIG. 13a the first set 73 and a second set 75 of grooved pulleys have come close to each other to allow the extension of the electric wire 54. The position shown in FIG. 13a corresponds to the picker cart 40 being driven into an end of a storage line.

In the position shown in FIG. 13b the belt 61 also is substantially fully extended and a major part of the electric wire 54 has been withdrawn from the cable winder 56. This position corresponds to the picker cart 40 being positioned on the picker transfer cart 28 and the lifting yoke 48 being substantially fully lowered for placing a package on the first conveyor. The electric wire 54 extends through an opening 51 in the top rail arrangement 30.

FIG. 14 shows further details of the picker cart 40. The lifting yoke 48 preferably is arranged to rotate goods that have been lifted before being positioned on a picking pallet. In the embodiment shown in FIG. 14 a rotation rim 64 is connected to a rotation motor 66 by a drive belt 68. The lifting yoke 48 is moved to be positioned appropriately over a package 16, normally in a direction perpendicular to the direction of the storage lines 12 by a yoke motor 70 and a transfer means 72 such as a chain. After positioning the lifting yoke 48 the lifting step is performed and the locking device (not shown in FIG. 14) can be activated as set out above. The electric motor 38 of the picker cart 40 is connected to a first wheel shaft 81 supporting support wheels 55. A second wheel shaft 83 is connected to the first wheel shaft 81 by a transfer belt 74. As set out above each wheel shaft preferably is doubled so as to provide two wheels radially displaced in a horizontal plan at each corner of the picker cart 40. The hoisting wheels 52 are driven by the motor and gearbox 53.

An alternative embodiment of a top shuttle 76 is shown in FIG. 15. It moves along a storage line on support wheels 55 on a suspension rail arrangement 32 as described above. A lifting yoke 80 is suspended on hoisting belts (not shown) on hoisting wheels 82 driven by a hoist motor 84. The top shuttle 76 is driven by the electric motor 38.

Instead of one suction device as described above a plurality of distributed suction devices 78 are used. Different subsets of the distributed suction devices 78, such as a first subset 86 comprising all suction devices in a row, or a second subset 88 comprising four top suction devices, can be engaged by a control system in dependence of different pattern of goods on the pallets.

The multi-storey goods storage arrangement in accordance with the invention handles pallets and baseboards with different sets and different types of packages, boxes and goods. When cardboard are used in packages the lifting means with suction devices described above can be used. If other types of packages are used the lifting means can comprise conventional mechanical lifting devices.

The front view of one embodiment of a multi-storey goods storage arrangement 10 in accordance with the invention of FIG. 16 shows four levels of storage lines 12 in which a plurality of baseboards 14 with goods 16 are stored. A baseboard transfer cart 20 shown on a lower level operates in a transport line 18 (into and out of the plane of paper shown in FIG. 16) and supports a shuttle 22. In the embodiment shown in FIG. 16 at least one baseboard transfer cart 20 operates along a transport line 18 at every second level. The shuttles 22 are moveable from the baseboard transfer carts 20 into storage lines 12 and back transporting baseboards 14 with good or packages 16. When moving in the storage lines 12 the shuttles 22 run on rails or directly in the horizontal load beams 36 formed as rails.

When situated on a baseboard transfer cart 20 the shuttle 22 is supported by a lifting gear 90 operating to lift the shuttle 22 from one level to a higher level and back. In various embodiments the lifting gear 90 comprises four gear racks 92, each gear rack 92 having an upright position in one corner of the baseboard transfer cart 20. The lifting gear 90 further comprises cogwheels 94 being arranged to engage the gear racks 92. The cogwheels 94 are connected to motors (not shown) and when rotated in synchronization the shuttle 22 will be moved vertically. In alternative embodiments chain drives are used to provide the lifting function.

In various embodiments the rails supporting the baseboard transfer cart 20 and the picker transfer carts 28 are provided with power lines supplying electrical power to the baseboard transfer cart 20 and the picker carts 40 through sliding contacts (not shown).

The baseboard transfer cart 20 and the picker carts 40 are provided with communication means 96 communicating with a central unit 95. The central unit 95 comprises a processing unit 96, a communication device 97 and memory means 98. The power lines in the rails can be used for communication between the central unit 95 and the baseboard transfer carts 20 and the picker transfer carts 28, respectively. Stationary data, such as dimensions, distances and performance of the multi-storey goods storage arrangement, carts and other units are stored in the memory means 98. Dynamic data relating to location and size of specific packages or goods, baseboard, speed of conveyors etc. are continuously received through the communication device 97 from carts and from a plurality of sensors and gauges arranged throughout the multi-storey goods storage arrangement. A control software running in the central unit continuously monitors and controls the function of the multi-storey goods storage arrangement. Information relating to different patterns or sets of packages is also stored and handled with the control software. As a result a picking pallet 14′ can be arranged in view of size and weight of each package that will be arranged on the picking pallet 14′.

FIG. 18 shows a shuttle 22 running on said horizontal load beams 36 in a storage line. The horizontal load beams 36 also supports baseboards 14. Normally, the shuttles 22 are provided with double shafts at each end to facilitate movement from the horizontal load beams 36 in a storage line to a corresponding rail arrangement in said baseboard transfer cart 20, each shaft supporting two shuttle wheels 100 similar to what is described above with reference to FIG. 4 and the picker carts 40.

In the alternative embodiment of a locking device as shown in FIG. 18 the locking arms have been replaced by a rigid chain mechanism 85. A rigid chain 87 runs in a curved support 89 having a height H extending the height of packages 16. The chain 87 is wound and extended by a chain belt motor 91. In the extended position as shown in FIG. 18 the package 16 lifted by the suction motor 62 and suction plate 71 can be locked in the shown position and supported by the rigid chain 87. The motor and gear box 53 and the threaded rods 63 operate as described above. By operating the chain belt motor 91 in a backward direction the rigid chain 87 can be withdrawn into said curved support 89 to allow the suction plate 71 supporting the package 16 to be hoisted to a lower position. Normally, two sets of chains 87 and curved supports 89 are used to provide a desired locking function.

FIG. 19 shows some of the system used for handling baseboards 14. In a section of the multi-storey goods storage arrangement baseboards 14 are stored and picked up by a baseboard picker 93 and disposed on the first conveyor 26 to become a picking baseboard 14′. Packages 16 then are placed on the picking baseboard 14′ by picker carts in a picking aisle 19 to complete a ready baseboard 14″. If a picking baseboard 14′ need to be set in a rest state waiting for further packages from other picker cart it is moved to a holding position 99 on either side of the first conveyor 26. Other picking baseboard 14′ then can be handled. Each one of the first conveyors 26 is provided with two holding positions 99 allowing a plurality of picking baseboards to be placed on hold.

While certain illustrative embodiments of the invention have been described in particularity, it will be understood that various other modifications will be readily apparent to those skilled in the art without departing from the inventive concept. Accordingly, it is not intended that the scope of the claims appended hereto be limited to the description set forth herein but rather that the claims be construed as encompassing all equivalents of the present invention which are apparent to those skilled in the art to which the invention pertains.

1. A multi-storey goods storage arrangement comprising a plurality of levels of storage lines arranged in parallel, each storage line supporting a plurality of baseboards with packages, and transport aisles extending in parallel between opposing ends of sets of said storage lines, wherein at least one baseboard transfer cart is operable along each transport aisle, comprising:
a central unit arranged for storing positions and present content of baseboards in memory means,
picking aisles extending in parallel between opposing ends of sets of said storage lines and in parallel with said transport aisles,
at least one picker transfer cart operating along each picking aisle, each picker transfer cart supporting at least one picker cart,
a top rail arrangement on said picker transfer cart from which said picker cart is suspended,
a suspension rail arrangement in said storage lines corresponding to said top rail arrangement to allow said picker cart to move out from said picker transfer cart, into said storage lines while suspended from said suspension rail arrangement, said picker cart comprising lifting means to lift a package stored in said storage lines and to transport said lifted package to a picking aisle, and
at least one first conveyor extending horizontally and supporting a baseboard for receiving goods from said at least one picking cart, wherein said lifting means comprises a lifting yoke for supporting a package and for releasing the package on said baseboard on said first conveyor.

2. A multi-storey goods storage arrangement as claimed in claim 1, wherein
said lifting yoke comprises a suction device having a surface to be firmly engaged to a package.

3. A multi-storey goods storage arrangement as claimed in claim 2, wherein
a locking device, said locking device extending below a package to lock said package in position on said lifting yoke.

4. A multi-storey goods storage arrangement as claimed in claim 2, wherein
said lifting yoke is connected to hoisting belts arranged on hoisting wheels driven by a motor and gearbox.

5. A multi-storey goods storage arrangement as claimed in claim 2, wherein
said suction device is electrically powered through electrical wire connected to a power outlet on said picker transfer cart, and
said suspension rail arrangement is provided with a recess for receiving said electric wire (54) when said suction device leaves said picker transfer cart.

6. A multi-storey goods storage arrangement as claimed in claim 5, wherein
said electrical wire is wound on a cable winder arranged to automatically adjust a free length of said electrical wire-when a distance between said power outlet and said suction device varies during operation.

7. A multi-storey goods storage arrangement as claimed in claim 6, wherein
said cable winder comprises a first set of grooved pulleys and a second set of grooved pulleys, said first set of grooved pulleys being connected to a tension motor through a belt, and
said tension motor is activated to pull said first set of grooved pulleys away from said second set of grooved pulleys when said suction device approaches said picker transfer cart.

8. A multi-storey goods storage arrangement as claimed in claim 3, wherein
said locking device comprises locking arms, each locking arm being connected to a threaded rod received in a nut with sprockets,
said nuts with sprockets are connected to be mutually rotated and thereby extending or withdrawing said threaded rods and moving said locking arms.

9. A multi-storey goods storage arrangement as claimed in claim 8, wherein
said nuts with sprockets are connected through a chain driven by a chain motor.

10. A multi-storey goods storage arrangement as claimed in claim 8, wherein
an interlock is provided in the nuts with sprockets to force the threaded rods and the locking arms to rotate 90 degrees together with the nuts with sprockets during a first step.

11. A multi-storey goods storage arrangement as claimed in claim 4, wherein
said first conveyor is arranged at a second level of said multi-storey goods storage arrangement, and
said hoisting belts have a length extending a height of two levels of said multi-storey goods storage arrangement so as to allow packaged to be lowered from a top level to said second level.

12. A method of operating a multi-storey goods storage arrangement comprising a plurality of levels of storage lines arranged in parallel, each storage line supporting a plurality of baseboards with packages, and transport aisles extending in parallel between opposing ends of sets of said storage lines, wherein at least one baseboard transfer cart is operable along each transport aisle, each baseboard transfer cart supporting at least one self-operated shuttle, comprising:
storing positions and present content of baseboards in a central unit,
providing an empty baseboard on a first conveyor at one level of said multi-storey goods storage arrangement,
said central unit directing a picker cart to pick up goods from a baseboard in a storage line and to suspend said goods from said picker cart in a lifting yoke,
said central unit directing a picker transfer cart supporting said picker cart to a position over said empty baseboard on said first conveyor,
lowering said lifting yoke until said goods engages said baseboard on said first conveyor,
releasing said goods on said baseboard on said first conveyor to form a picking baseboard,
optionally adding further goods on said picking baseboard until a completed ready pallet is formed,
delivering said ready pallet from said multi-storey goods storage arrangement.
